(19) United States
(12) Patent Application Publication
(10) Pub. No.: US 2012/0163932 A1
(43) Pub. Date: Jun. 28, 2012

(54) Accessory For a Power Drill and Control Method

(76) Inventors: Peer Schmidt, Lindau (DE); Roland Schaer, Grabs (CH); Alexander Liniger, Zuerich (CH); David Leuzinger, Zuerich (CH)

(21) Appl. No.: 13/334,771

(22) Filed: Dec. 22, 2011

(30) Foreign Application Priority Data
Dec. 23, 2010 (DE) 102010064118.9

(51) Int. Cl. B23Q 17/24; B23Q 17/22; B23B 49/00

(52) U.S. Cl. 408/1 R; 408/16

(57) ABSTRACT

An accessory is provided that can be connected to a power drill or can be fastened at the power drill in a detachable fashion. The accessory may comprise detachable or fixed means for fastening at the power drill, e.g., clips, sleeves, clamps, screws. A measuring device is provided to determine measurements, including an incline of the power drill in reference to an operating surface and/or a distance of the power drill from the operating surface. A projector is provided to project the symbols according to the measurements determined to the operating surface.

### RELATED APPLICATIONS

The present application claims priority to German Patent Application DE 10 2010 064 118.9 filed Dec. 23, 2010 and entitled “Hilfseinrichtung einer Bohrmaschine and Steuerungsverfahren” (“Accessory for a Power Drill and Control Method”), the entire content of which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to an accessory for a power drill to indicate the measurements of the power drill.

### BRIEF SUMMARY OF THE INVENTION

An accessory according to aspects of the present invention is connected to a power drill or can be fastened at a power drill in a detachable fashion. The accessory may be provided with detachable or permanent means for fastening at the power drill, e.g., clips, sleeves, clamps, screws. A measuring device is provided in order to determine measurements regarding the incline of the power drill in reference to an operating surface and/or a distance of the power drill from the operating surface. A projector is provided to appropriately project symbols of the measurements detected to the operating surface. One embodiment provides that the projector is arranged radiating in an operating direction of the power drill.

A control method according to aspects of the invention for an accessory has the following steps: determining measurements of the power drill via a measuring device and projecting via a projector the measurements to a surface processed by the power drill. The operating surface becomes the display surface. The user can keep focusing on the operating surface and is not forced to look to a display arranged at the power drill. This way, a safe and pleasant operation is achieved.

One embodiment provides that the projector comprises a display optic and an illuminated monitor with several electro-optic illuminants, which can be addressed individually. In this embodiment, the display of the monitor itself cannot be viewed by the user, however the image projected by the display optic can be seen. The monitor comprises a sufficient number of symbols or pixels, which can be individually addressed and can display different measurements. A first group of illuminants is switched lucent for first measurements and a second group of illuminants is switched lucent for second measurements, with the first group differing from the second group by at least one illuminant when the first measurements and the second measurements are different.

One embodiment comprises a laser source, an intensity modulator, and a pivotal minor animated by an inciter, which deflects the laser beam in the direction towards the operating surface. The intensity modulator can be controlled according to the symbol to be displayed. The light beam is deflected by the moving mirror over the operating surface. The intensity modulator switches off the light beam when it would reach sections outside a symbol to be displayed, and switches the light beam back on as soon as it reaches an area inside the symbol to be displayed.

One embodiment provides the following steps: projecting with the projector a first light spot and a second light spot; recording the first light spot and the second light spot in an image via a camera; determining a virtual first distance of the first light spot, recorded in the image, from a reference point; determining a virtual second distance of the second light spot, recorded in the image, from the reference point; determining the incline of the power drill in reference to the operating surface based on the first distance and the second distance; and displaying the incline via the projector. The projector already used for displaying measurements can also be used as a part of a measuring device. Being another part, the camera records the pattern projected by the projector onto the operating surface and the processing device determines therefrom an incline and/or distance.

One embodiment provides that a first light beam is emitted in a first direction for creating the first light spot, a second light beam in a second direction for creating the second light spot, and a third light beam in a third direction for creating a third light spot, with an azimuth angle of the first light beam in reference to the optic axis of the camera and an azimuth angle of the second light beam in reference to the optic axis of the camera being different, and an amplitude of the first light beam in reference to the optic axis and an amplitude of the third light beam in reference to the optic axis being different. The three light beams allow conclusions concerning the incline and distance in absolute values. The determined values can be displayed to the user, for example, in the form of numbers.

### BRIEF DESCRIPTION OF SEVERAL VIEWS OF THE DRAWINGS

The following description explains the invention based on exemplary embodiments and figures.

FIG. 1 illustrates a power drill with an accessory formed in accordance with an embodiment of the present invention.

FIG. 2 illustrates an image recorded by an accessory formed in accordance with an embodiment of the present invention.

FIG. 3 illustrates a detailed view of an optic measuring device of an accessory formed in accordance with an embodiment of the present invention.

FIG. 4 illustrates a detailed view of an optic measuring device of an accessory formed in accordance with an embodiment of the present invention.

FIG. 5 illustrates a monitor of a display device of an accessory formed in accordance with an embodiment of the present invention.

FIG. 6 illustrates a projector of a display device of an accessory formed in accordance with an embodiment of the present invention.

FIG. 7 illustrates a projector of a display device of an accessory formed in accordance with an embodiment of the present invention.

In the figures, identical or functionally identical elements are identified by the same reference character, unless stipulated otherwise.

### DETAILED DESCRIPTION OF THE INVENTION

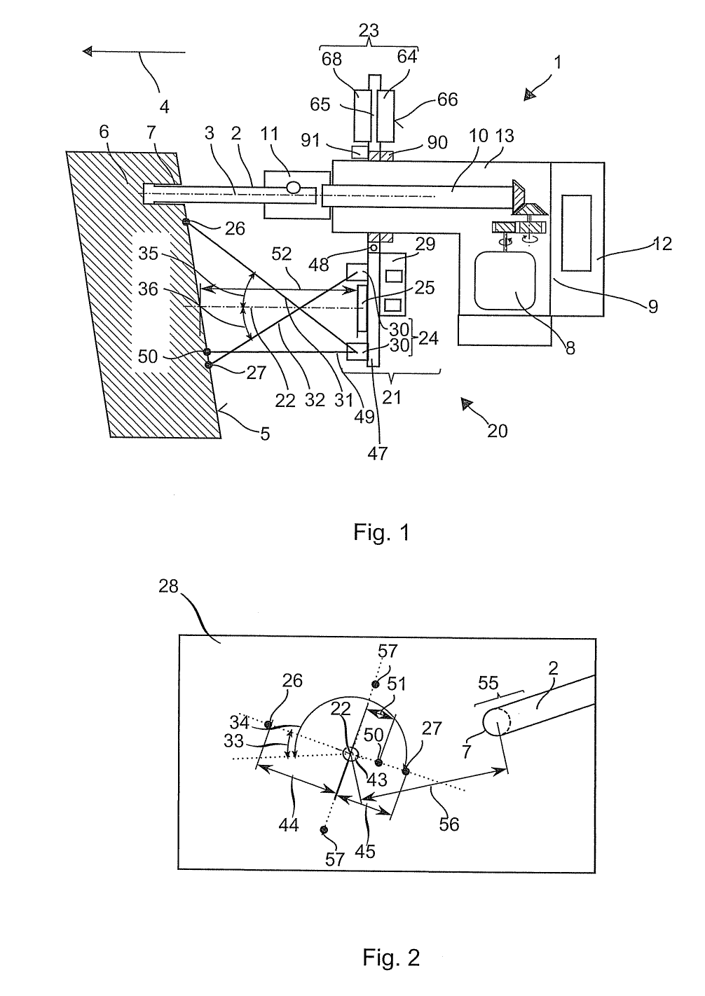

FIG. 1 shows an exemplary power drill 1, formed in accordance with an embodiment of the present invention, which can rotationally drive a drill bit 2 about an operating axis 3. The user presses the drill bit 2 in the operating direction 4 to an operating surface 5 of a work piece 6 to be processed. Here, the rotating drill bit 2 creates a bore hole 7 in the work piece 6. The drill bit 2 comprises a cutting element made from hard metal, e.g., sintered tungsten carbide and/or diamond, which removes material from the work piece 6 by rotating about the axis. The shavings can be removed via the helical shaft or a hollow shaft of the drill. The cutting elements may also be arranged along a circular face of a cup-shaped drill.

The drive may comprise a motor 8, e.g., an electric motor, a transmission 9, and a drive screw 10. The drive screw 10 transfers the torque to a tool accept 11, into which a drill bit 2 can be inserted. The user can hold and/or guide the power drill 1 via a handle 12, which is arranged preferably at an end of the machine housing 13 distanced from the tool accept 11.

An accessory 20 renders it easier for the user to align the operating axis 3 of the power drill 1 to a desired angle, preferably perpendicularly, in reference to the processed operating surface 5 and to guide it in the aligned form. An optic measurement device 21 can detect the orientation of its optic axis 22 in reference to the work piece 6. A display device 23 shows the present orientation to the user. Additionally, the accessory 20 can determine a present drilling depth and visualize it via the display device 23.

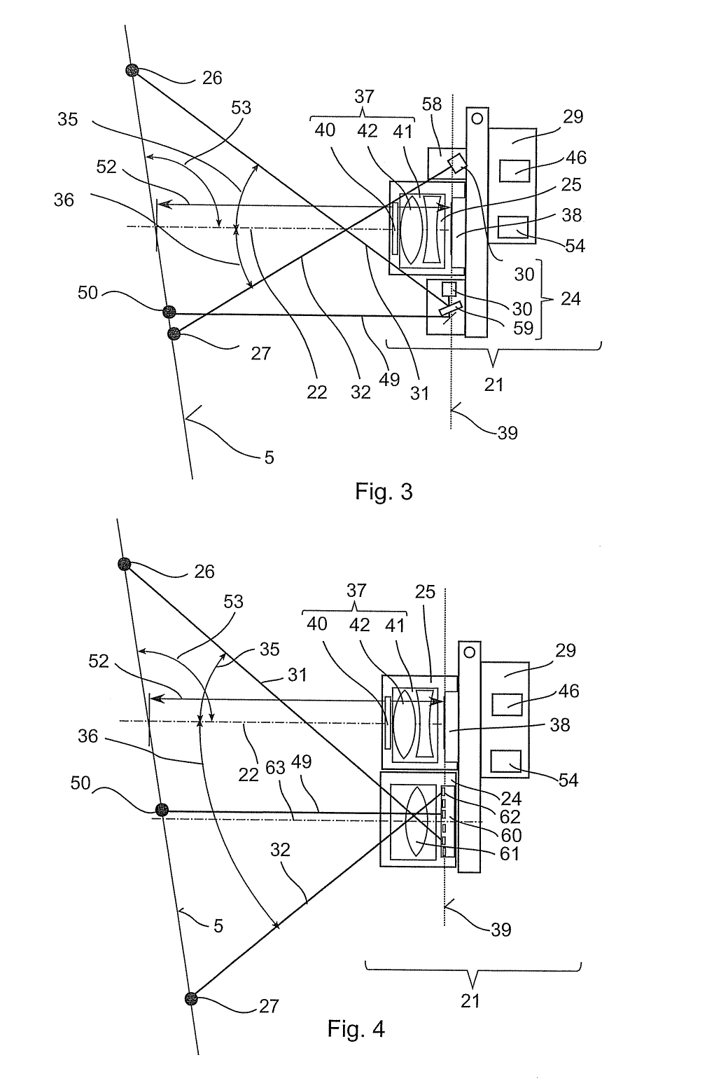

The optic measuring device 21 of the accessory 20 comprises a projector 24 and a camera 25, which are shown in detail in FIG. 3. The projector 24 creates at least one first light spot 26 on the operating surface 5 and a second light spot 27. The camera 25 is preferably arranged on the optic axis 22 and records the operating surface 5 and the light spots 26, 27 created thereon in an image 28 (FIG. 2). Based on the image 28 and the light spots 26, 27 recorded, a processing device 29 determines an orientation of the optic axis 22 in reference to the operating surface 5.

An example of a projector 24 includes two laser light sources 30, e.g., laser diodes, which create a first light beam 31 and a second light beam 32. The first light beam 31 is emitted in a first direction and the second light beam 32 in a second direction, which is different from the first direction.

The direction of the light beams 31, 32 is stated in the following in the form of angular coordinates in reference to the optic axis 22. The amplitude describes the incline of the light beam in reference to the optic axis 22 in a level, which is stretched between the light beam and the optic axis 22. An azimuth angle represents the orientation of the light beam in a rotational direction about the optical axis 22 and can be determined in a projection to a level perpendicular in reference to the optic axis 22 (cf. FIG. 2).

Preferably, a first azimuth angle 33 of the first light beam 31 differs from a second azimuth angle 34 of the second light beam 32. The first azimuth angle 33 may differ by 180 degrees from the second azimuth angle 34, i.e. the two light beams 31, 32 are located in a level with the optic axis 22. A first amplitude 35 of the first light beam 31 and a second amplitude 36 of the second light beam 32 may be identical. The amplitudes 35, 36 are preferably at a range from about 10 degrees to about 60 degrees. The projector 24 can emit light beams 31, 32 intersecting the optic axis 22.

The first light beam 31 leads to the first light spot 26 on the operating surface 5 and the second light beam 32 to the second light spot 27. The relative orientation of the optic axis 22 in reference to the work piece 6 can be determined from the relative position of the first and the second light spot in reference to the optic axis 22 and the distances. The light beams 31, 32 emitted by the projector 24 may show a circular cross section or a different shape. Light spots of small diameters are preferred due to their easily determined position, however differently shaped light spots (e.g., non-circular shapes, arrows, crosses) may be projected to the work piece 6 as well.

The camera 25 records the operating surface 5 with the light spots 26, 27 on the work piece 6. The camera 25 may include a display optic 37, which displays the operating surface 5 on a spatially resolving photo sensor 38. The photo sensor 38 converts the incoming light into an image 28, which, spatially resolved in an image level 39, displays an intensity of light. The light spots 26, 27 are beneficially of such brightness that they show the highest intensity displayed in the image 28. A color filter 40 adjusted to the color of the light spots 26, 27 may be arranged to amplify the contrast in front of the photo sensor 38.

The display optic 37 may comprise an objective 41 comprising one or more lenses 42. The lenses 42 are preferably arranged centrally and perpendicularly in reference to the optic axis 22. Instead or in addition to the objective 41 an aperture may also be provided. The projector 24 and the camera 25 are arranged distanced from each other such that the first light spot 26 is detected by the camera 25 at a direction different from the first direction and the second light spot 27 at a direction different from the second direction.

A processing device 29 reads the image 28 from the camera 25, particularly the spatially resolving photo sensor 38. The brightest spots of the image are interpreted as the virtually displayed light spots 26, 27. The position of the displayed light spots 26, 27 in reference to a reference point 43 in the image 28 or in the image level 39 is determined by the processing device 29. In the image 28 a first distance 44 of the first light spot 26 is measured from the reference point 43, and a second distance 45 of the second light spot 26 from the reference point 43 is also measured. The distances measured are virtual. The measuring may include a determination of the coordinates of the light spots 26, 27 in the image. In order to determine the distances 44, 45, distances allocated to the coordinates are stored in the reference table in a storage element 46, e.g., RAM, flash-RAM of the processing device 29. The reference point 43 may be set arbitrarily. Preferably, the reference point 43 represents the interface of the image level 39 with the optic axis 22 or the center of the image 28.

An operating mode of the accessory 20 supports the user in the perpendicular alignment of the power drill 1 in reference to the work piece 6. The accessory 20 is fastened at the power drill 1 such that the optic axis 22 is parallel to the operating axis 3. The processing device 29 transmits a control signal, which indicates that the optic axis 22 in reference to the work piece 6 is at an incline when the first distance 44 is different from the second distance 45. The control signal indicates in which direction the distances 44, 45 are greater. The display device 23 visualizes the control signal to the user. For example, the display device 23 shows an arrow indicating the direction. The user will pivot the handle 12 in the direction about the bore hole based on the indication until the distances 44, 45 are of equal size and the optic axis 22 is perpendicular in reference to the work piece 6.

The optic measuring device 21 may be arranged at a platform 47 pivotal in reference to the operating axis 3. In particular, an amplitude may be adjusted between the optic axis 22 and the operating axis 3. The platform may for example be fastened via a ball joint 48 or pivotal joints at the housing of the power drill 1. A user adjusts a desired, e.g., not parallel, orientation of the optic axis 22 in reference to the operating axis 3. The processing device 29 and the display device 23 indicate to the user to guide the power drill 1 with the optical axis 22 perpendicularly in reference to the work piece 6. A drilled bore hole then has an incline in reference to the operating surface 5, which is equivalent to the adjusted orientation of the operating axis 3 in reference to the optic axis 22.

In another operating mode the accessory 20 can determine the absolute angle of the optic axis 22 in reference to the operating surface 5. The projector 24 creates a third light beam 49, which is preferably parallel in reference to the optic axis 22 and off-set in reference to the optic axis 22. Instead of being parallel, the third light beam 49 may also show a slight amplitude, compared to the first light beam 31, in reference to the optic axis 22, e.g., ranging from about 0 degrees to about 5 degrees. A resulting third light spot 50 is detected by the camera 25. A virtual third distance 51 of the displayed light spot 50 from the reference point 43 in the image 28 is determined. Based on the third distance 51 the distance 52 of the camera 25 from the work piece 6 is determined. The third distance 51 increases in the image 28 with the distance 52 reducing. Based on the distance 52, the first distance 44, and the second distance 45 and the amplitude 35 of the first light beam 31 and the amplitude 36 of the second light beam 32 the incline 53 of the optic axis 22 can be absolutely and quantifiably determined in reference to the operating surface 5. Preferably, amplitudes 35 are stored in the storage element 46 equivalent to first, and second distances allocated to various distances 52. The display device 23 preferably displays the absolute angle in the form of a number.

Another embodiment provides that the first light beam 31 and the second light beam 32 show a different amplitude 35, 36 from the optic axis 22. The two light beams 31, 32 may extend in a level, which for example includes the optic axis 22. Preferably the first light beam 31 is parallel to the optic axis 22, and the second light beam inclined in reference to the optic axis 22. Using the optic axis 22 as the reference point 43, the absolute incline 53 of the optic axis 22 in reference to the operating surface 5 can be directly determined from the first distance 44 and the second distance 45.

The photo sensor 38 may comprise a plurality of photosensitive cells, which are arranged on a grid. Coordinates of a light spot represent the cell and perhaps the column of the cell respectively illuminated by the light spot 26, 27. One cell may be determined as the reference point 43. The photo sensor 38 may include for example a CCD chip or an APS sensor.

The camera 25 may record the bore hole 7 in the operating surface 5 and the drill bit 2 in the image 28. The processing device 29 includes an image detection 54, which identifies the bore hole 7 and determines its coordinates in the image 28. The image detection 54 may, for example, first identify the drill bit 2, e.g., using its oblong shape and/or based on a known orientation of the drill bit 2 in the image 28, which due to a fixed or known arrangement of the camera 25 results in reference to the drill bit 2. The coordinates of one end 55 of the visible part of the drill bit 2 are equivalent to the coordinates of the bore hole 7. In the image 28 a distance 56 of the bore hole 7 from the reference point 43 is determined. The distance 56 is a measure for the distance 52 of the camera 25 from the bore hole 7 and thus the operating surface 5. The processing device 29 can determine a distance of the power drill 1 based on the measurement and transmit it to the display device 23 for visualization. The distance 52 may also be used to determine the absolute angle 53.

The above-described embodiments can determine an incline deviating from the perpendicular or an absolute angle 53 of the optic axis 22 in reference to the work piece 6 in a first level. A further development provides additional light beams, which show azimuth angles differing by 90 degrees from the first and the second light beam 31, 32. The processing of the light spots 57 of the other light beams may occur similar to the one of the first and second light beam 31, 32. This way, the incline of a second level is determined in reference to the first perpendicular level. In order to determine the absolute angle 53, additionally the third light beam 49 may be used, which shows a different amplitude to the other light beams 31, 32 in reference to the optic axis 22. In one embodiment three light beams show different orientations, with two of them differing at least in their azimuth angles, and two at least in the amplitude. In addition to or instead of the third light beam 49 the measuring of the distance 56 of the bore hole 7 from the optic axis 22 can be used in the image 28 to determine the distance.

The projector 24 may be composed from several individual, independent laser sources 30. The laser diodes 30 may be arranged in a housing 58 according to the predetermined directions of the laser beams. The projector 24 may also comprise a beam splitter 59, in order to split a light beam into two light beams 31, 49. The beam splitter 59 may for example comprise a glass plate or a bundle of fiberglass.

In one embodiment the projector 24 alternatively or additionally comprises an illuminating monitor 60 and a display optic 61 (FIG. 4). The monitor 60 may represent, for example, a background-lit liquid crystal display, a matrix of light diodes, etc. The monitor 60 can display symbols composed from several light spots 62. The display optic 61 displays the image shown on the monitor 60 on the operating surface 5. The display optic 61 may include one or more lenses arranged along an optic axis 63 of the display optic 61. The optic axis 63 extends through the monitor 60, preferably through the center of the monitor 60. Image spots near the optic axis 63 lead to largely parallel light beams in reference to the optic axis 22, while image spots near the monitor edge are projected to the operating surface 5 by light beams 31, 32 inclined in reference to the optic axis 63. The incline of the light beams can be adjusted by the focal length of the display optic 61.

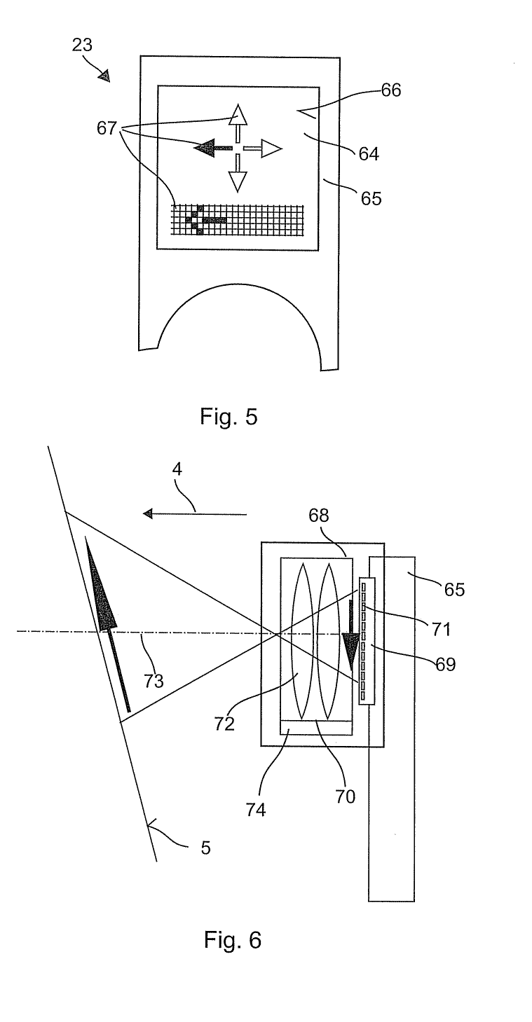

The display device 23 comprises a monitor 64 fastened to a carrier 65 of the accessory 20. The monitor 64 faces the user with its readable area 66, i.e. oriented against the operating direction 4. The user can read the information on the monitor 64 when guiding the power drill 1 in the operating direction 4. Several electro-optic segments 67 can be switched independently of each other between the light and the dark status (FIG. 5). The segments 67 may be illuminating, e.g., a cell or a matrix of light diodes, or covering a background illumination, e.g., several liquid crystal cells. The segments 67 may be embodied in the form of arrows, which are arranged rotated in 90-degree steps. In an incline of the optic axis 22 in reference to the operating surface 5 one of the segments 67 each is activated according to the control signal of the processing device 29. The segments 67 may also be embodied as a plurality of image spots on a grid, which activated together show arrows, numbers, letters, etc. The example of FIG. 5 shows a group of segments 67 switched dark, which indicate an incline to the right and thus prompt the user to pivot the power drill 1 to the left. The segments 67 are arranged on a surface of the accessory 20 facing away from the tool 2. The user can directly read the directions shown on the accessory 20.

For example, the display device 22 comprises a projector 68, which projects information to be displayed by the display device 22 to the operating surface 5 (FIG. 6). The projector 68 points in the operating direction 4. The projector 68 may also show a self-illuminating monitor 69 and a display optic 70.

The monitor 69 is composed of several individually addressed, electro-optic light elements 71. Each of the electro-optic elements 71 can emit light in a switched state and in another switched state can emit no light. The electro-optic elements 71 may for example comprise background-illuminated liquid crystal displays, punctual or other geometrically designed light diodes, a field of micro-reflectors illuminated by a lamp, etc. As an example, the monitor 69 is shown with several electro-optic elements 71, which are arranged on a grid. The image spots may be lit individually or in groups in order to display one or more desired symbols. The symbols are arrows, numbers, letters, etc. The measuring device 21 controls the projector 68. Here, depending on data transmitted by the measurement device 21, different groups of electro-optic elements 71 are switched lucent. The groups differ in pairs at least in one element 71, which is switched for one group illuminating and the other group non-illuminating.

The display optic 70 displays the symbols shown on the monitor 69 on the operating surface 5. The display optic 70 comprises an objective 72 made from one or more lenses. The focal length and a focal point of the objective 72 may be adjustable. For example, the objective 72 may be mobile along its optical axis 73 by a sled 74. Alternatively, the objective 72 may comprise a liquid lens, with its focal length being adjustable by applying an electric field.

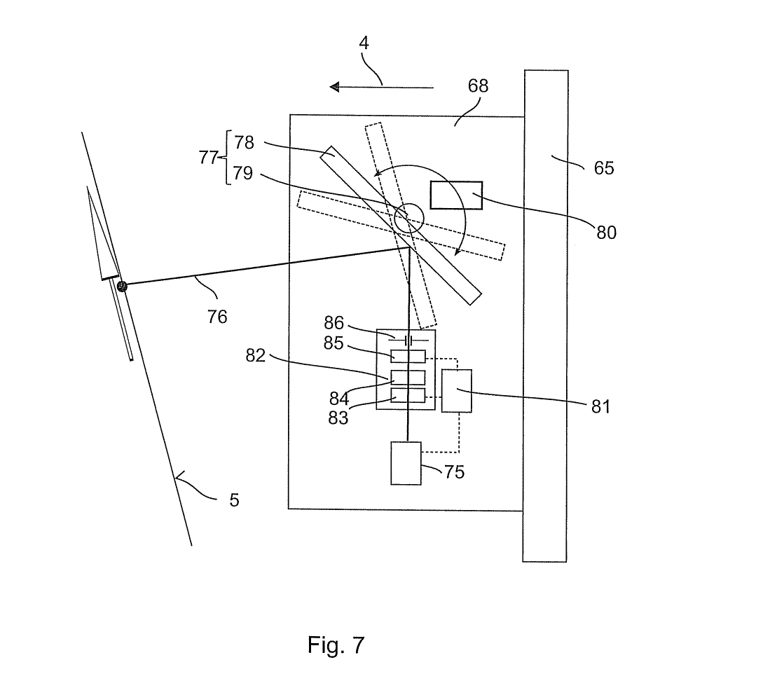

Another embodiment of the projector 68 has a light source 75 to create a light beam 76, preferably a laser, and a deflection device 77 (FIG. 7). The deflection device 77 has a minor 78, for example, which is suspended rotationally or pivotally about two axes 79. The mirror 78 may also be animated by an exciter 80, e.g., piezo-electrically, magnetically, or electrostatically, to pivot about the two axes 79. The mirror 78 may also be rotational about one or both axes 79. Two pivotal or rotating minors may also be provided for the defection of the light beam 76 in two directions. The light beam 76 is deflected along a grid, e.g., of a Lissajous-figure over the operating surface 5.

A control device 81 switches an intensity of the light beam 76 depending on the position of the deflection device 77 in order to project symbols to the operating surface 5. A switching pattern may be stored in a storage component of the control device 81 for various symbols required, e.g., arrows, numbers. The switching patterns determine the intensity in reference to the angular position of the minor 78. The intensity of the light beam 76 is reduced as soon as the light beam 76 is outside the areas of the symbols. The switching of the intensity may occur by switching a power supply for the light source 75 via the control device 81. Furthermore, the switching can occur by an intensity modulator 82, which comprises e.g., a combination of a Pockels cell 83 to change polarization and a subsequent polarization filter 84 and/or a combination of an acoustic-optic modulator 85 to change the direction of distribution of the light beam and a subsequent blind 86.

One embodiment provides to also use the projector 68 of the display device 23 for the display of measurements for the generation of light spots 26, 27 on the operating surface 5 to measure via the measuring device 21. An additional projector 24 of the measuring device 21 can be omitted.

The accessory 20 may comprise a tensile tape 90, which can be wrapped around a neck 91 or a handle of the power drill 1. The tensile mechanism 91 clamps the tensile tape to the power drill 1. Instead of a tensile tape, clips may also be clamped to the power drill 1 by the tensile mechanism 91.

1. An accessory for connecting to a power drill, the accessory comprising:
a measuring device to determine measurements, the measurements including at least one of the incline of the power drill in reference to an operating surface and the distance of the power drill from the operating surface; and
a projector configured to project symbols to the operating surface according to the measurements determined.

2. An accessory according to claim 1, wherein the projector is arranged emitting in an operating direction of the power drill.

3. An accessory according to claim 1, wherein the projector comprises a display optic and an illuminating monitor comprising a plurality of individually controlled electro-optic illuminators.

4. An accessory according to claim 3, wherein a first group of illuminators is designed lucent for first measurements and a second group of illuminators is designed lucent for second measurements, with the first group being different from the second group by at least one illuminator when the first measurements and the second measurements are different.

5. An accessory according to claim 1, comprising a laser source, a control device for modulating an intensity of a light beam emitted by the laser source, and a reflector animated rotationally or pivotally by an exciter, which deflects the light beam in the direction towards the operating surface.

6. An accessory according to claim 5, wherein the control device comprises an intensity modulator which is penetrated by the light beam, and at least one of an acoustic-optic element or a polarization modulator.

7. An accessory according to claim 1, wherein the accessory comprises a detachable fastening device configured to fasten the accessory to the power drill.

8. A control method of an accessory for a power drill comprising:
determining measurements of the power drill via a measuring device; and
projecting the measurements via a projector to an operating surface processed by the power drill.

9. A control method according to claim 8, comprising:
projecting a first light spot and a second light spot with the projector to the operating surface;
recording the first light spot and the second light spot via a camera in an image;
determining a first distance of the first light spot recorded in the image from a reference point and a second distance of the second light spot recorded in the image to the reference point;
determining an incline of the power drill in reference to the operating surface based on the first distance and the second distance; and
displaying the determined incline via the projector.

10. A control method according to claim 9, wherein a first light beam is emitted in a first direction to create the first light spot, a second light beam is emitted in a second direction to create the second light spot, and a third light beam is emitted in a third direction to create a third light spot, with the azimuth angle of the first light beam and the second light beam being different in reference to the optic axis of the camera, and the amplitude of the first light beam and the third light beam being different in reference to the optic axis.
